(19) United States
(12) Patent Application Publication
(10) Pub. No.: US 2023/0267899 A1
(43) Pub. Date: Aug. 24, 2023

(54) AUTOMATIC AUDIO MIXING DEVICE

(71) Applicant: NUSIC LIMITED, Wan Chai, Hong Kong (CN)

(72) Inventor: Adam PLACE, Totnes (GB)

(21) Appl. No.: 17/910,484

(22) PCT Filed: Mar. 11, 2020
(86) PCT No.: PCT/CN2020/078803

§ 371 Date: Apr. 24, 2023

(51) Int. Cl. G10H 1/00; G10H 1/38; G10H 1/40

(52) U.S. Cl. CPC G10H 1/0025; G10H 1/38; G10H 1/40; G10H 2210/076; G10H 2210/081; G10H 2210/375; G10H 2210/571

(57) ABSTRACT

The present invention provides an automatic mixing device, including: a music feature calculator. Input music of the music feature calculator includes melody, bass, percussion music, and vocal tracks; the music feature calculator selects one or more of the melody track, bass track, percussion track, and vocal tracks, and calculates one or more features of the input music, including beat point time, a chord at a downbeat, a chroma vector at a downbeat, sound energy at a downbeat, tonality and tempo. The automatic mixing device of the present invention can calculate music features in the music according to different audio tracks and automatically calculate mixing points according to the music features, thereby achieving the automation of mixing and solving the problem of low mixing efficiency, unnatural mixing effect, and the like in the prior art.

### TECHNICAL FIELD

The present invention relates to the field of mixing, and in particular relates to an automatic mixing device.

### BACKGROUND ART

Mixing generally refers to the operation in which a disc jockey (DJ for short) selects and plays pre-recorded music (such as pop songs) and combines the music with a computer on-site to create unique music that is different from the original music. Software to assist the DJ in mixing includes Traktor, Serato, Mixed in Key, etc. Such software is based on similarities of music rhythm and tonality. They can assist the DJ in manually adjusting the tempo and tonality of the music. This type of DJ mixing connects music in series, by playing another piece of music in place of the previous one.

However, such manual mixing mode has low efficiency, high cost and few applicable scenes. In order to improve efficiency, there are commercial solutions in the market to assist users in selecting and mixing music. Most of these solutions are based on the similarities of music rhythm and tonality, and one piece of music is integrally replaced by another. Although such a design provides some prompts assisting a user in operation, the user needs to manually select the music to be replaced and specify a time point for the replacement of the music. The replacement time point (mixing point) cannot be calculated completely automatically. Moreover, multi-track music is not considered, and a replacement part of one piece of music will be replaced wholly by a section of another piece, resulting in an excessively unnatural replacement result. In addition, some solutions have chord comparison but have no special processing on a vocal track, and a chord detection error rate is also extremely high.

### SUMMARY OF THE INVENTION

Given the above disadvantages of the prior art, the objective of the present invention is to provide an automatic mixing device for taking one piece of music selected by a user as a verse and selecting several other pieces of similar music from a calculated database, to find mixing points of the parts that can be replaced in the verse and the similar music. The present invention aims to provide an automatic mixing device to solve the problems of incapability of automatic mixing point calculation, unnatural mixing results and high error rate in the prior art.

In order to achieve the above objective and other related objectives, the present invention provides an automatic mixing device, including: a music feature calculator, input music of the music feature calculator including a melody track, a bass track, a percussion track, and a vocal track; the music feature calculator selecting one or more of the melody, bass, percussion music, and vocal tracks, and calculating one or more features of the input music, including beat point time, a chord at a downbeat, a chroma vector at a downbeat, sound energy at a downbeat, tonality, and tempo.

According to the mixing device of the present invention, music features of the music can be calculated according to different audio tracks, and mixing points can be automatically calculated according to the music features, such that automatic mixing is achieved, the problems of low mixing efficiency, unnatural mixing effect, and the like in the prior art are solved, and therefore, the automatic mixing device has extremely high industrial application value.

### DESCRIPTION OF DRAWINGS

FIG. 1 is a flowchart of a music feature calculator according to the present invention;

FIG. 2 is a schematic diagram of a music segment; and

FIG. 3 is a flowchart of mixing point calculation.

### DETAILED DESCRIPTION

Implementations of the present invention are described below through specific examples, and those skilled in the art could easily understand other advantages and effects of the present invention from the contents disclosed in this specification. The present invention may also be implemented or applied in other different specific implementations, and various details in this specification may also be variously modified or changed based on different viewpoints and applications without departing from the spirit of the present invention.

Please refer to the figures. It should be noted that the drawings provided in the present embodiment only schematically illustrate the basic concept of the present invention, so only components related to the present invention are shown in the drawings rather than being drawn according to the numbers, shapes and sizes of the components in actual implementation. The forms, numbers and scales of the components can be changed freely in actual implementation, and the layout forms of the components may also be more complex.

The automatic mixing device of the present invention includes a music feature calculator and a mixing point calculator. The music feature calculator and the mixing point calculator are respectively introduced below with reference to the figures.

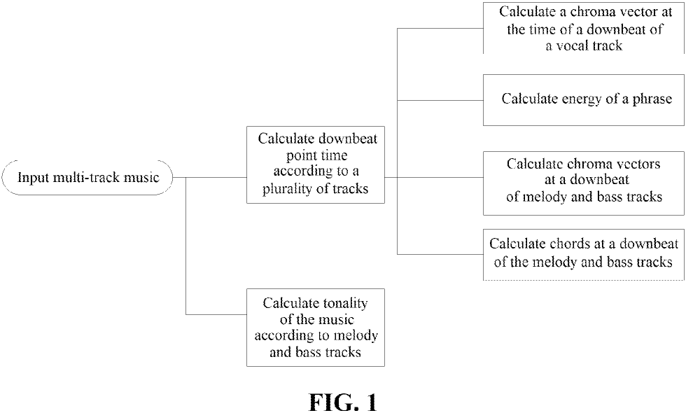

Referring first to FIG. 1, FIG. 1 being a flowchart of the music feature calculator according to the present invention. Music features defined by the music feature calculator according to the present invention include the beat point time and downbeat time of the music, a chord and a chroma vector at a downbeat of the music, sound energy at a downbeat of the music, and rhythm and tonality of the music. The calculation result of the music feature plays a vital role in finding the mixing point.

The input to the music feature calculator includes four tracks: melody, bass, percussion, and vocal tracks. Different track combinations are required for different feature calculations. A preferred embodiment of calculating each music feature is described below respectively:

Beat point time and downbeat time of the music: the downbeat of the music refers to the first beat of each bar. A common piece of music has four beats per bar, one downbeat is taken from every four beats. The time of the first downbeat needs to be calculated, and one downbeat is taken from every four beats after the first beat point is obtained. For example, the music beat point may be found using conventional methods such as calculating the correlation of music occurrence time in signal processing. In this embodiment, the beat point time of the music is calculated by using a plurality of recurrent neural networks in deep learning. The time of the first downbeat is calculated from the calculated beat time through a hidden Markov model. There are many implementation tools for these methods, such as a madmom software package, in which DBNDownBeatTracking Processor can be used to calculate the beat point time of the music. That method’s input is melody, bass and percussion tracks. The vocal track is not used for calculating the music beat point to avoid the interference of the downbeat calculation.

Chord at a downbeat of the music: after the downbeat time of the music is obtained, a chord feature of the music is calculated by using a convolutional neural network, and the input adopts melody and bass tracks. After the chord feature of the music is obtained, the chord at this downbeat point is identified through a conditional random field method.

Chroma vector at a downbeat of the music: the chroma vector refers to a multi-element vector used for representing the energy of each sound level (the energy of the sound level is proportional to the sound amplitude of the sound, and a calculation method thereof can refer to the calculation of mechanical wave energy and will not be repeated here) within a period of time (such as one frame). In this embodiment, the chroma vector has 12 elements, these elements respectively represent the energy in 12 sound levels within a period of time (such as one frame), and the energy of the same sound level in different octaves is accumulated. For the vocal track, the melody track and the bass track, based on a deep neural network method, a harmonic spectrum can be calculated and the chroma vector can be extracted.

Sound energy at a downbeat of the music: in this embodiment, a square root mean of sound wave amplitudes at a downbeat point is calculated as the energy of the downbeat point.

Tonality of the music: in this embodiment, the tonality of the whole music is calculated by using a convolutional neural network, and the input adopts melody and bass tracks.

Tempo: the tempo can be calculated by beats. The formula for calculating the tempo is

$$\frac{60}{b e a {t}_{i + 1} - b e a {t}_{i}}$$

where beat refers to a beat of a phrase, and i is a sequence number of the beat. Although the tempo can be calculated through the duration time of the whole music and the total number of beats, such a calculation method is time-consuming. Through experimental data, the tempo generally turns to be stable after a period of time, i.e., if sampling is performed at a proper position in the middle of the music. In that case, the tempo calculated through the sampling point is extremely similar to a tempo value calculated through the duration time of the whole music and the total number of beats. This calculation through the sampling point is faster. Through a large amount of experimental data, the 20th to 90th beats of one piece of music is generally stable, and i is 70 in this embodiment.

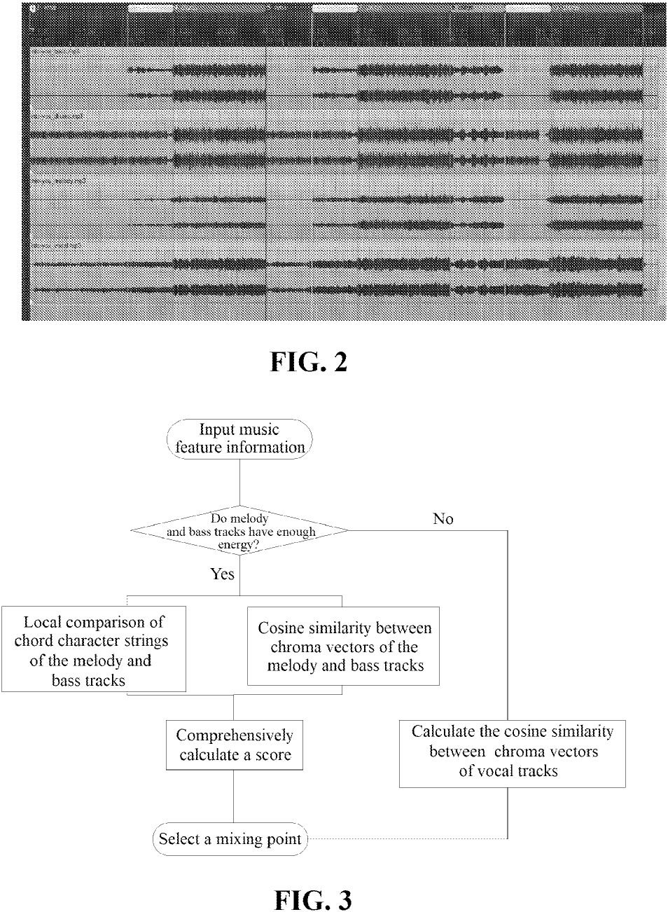

After music feature values are obtained, the mixing points can be calculated based on the music feature values. In this embodiment, the automatic mixing device preferably further includes a music segmenter configured to divide the music prior to calculating the mixing points. The structure of the music can be divided into a prelude, a chorus, a verse, a bridge and a postlude. Some toolkits implement the calculation of a music segment, such as MSAF software package. MSAF software package can set many different algorithms to look up a music segment, and a structure feature-based method is used in this embodiment. FIG. 2 is a schematic diagram of a music segment. The music segment includes the prelude, verse, chorus, bridge, etc. In order to find more mixing points, the length of the music segment is divide into phrases that are integer multiples of 4 bars, and the phrases of 4 bars, 8 bars and 16 bars are mutually compared to find the mixing points of the music. Experiments show that the probability of detecting the mixing points is the highest when the music is divide into phrases that are integer multiples of 4 bars.

The steps of calculating the mixing points are described in detail below in conjunction with FIG. 2. The phrase of each length in the verse is compared with the phrase of the same length in other music, to determine whether the two phrases are of the same structure. For example, the phrase in the verse is only compared with the phrase in the verse in other music. Before comparison, it needs to be determined that the two phrases have enough energy. The phrase’s energy is calculated using each beat’s previously calculated energy. If the two phrases both have enough energy, the following comparison is further carried out.

Mixing point calculation of the percussion music: comparison of the percussion music does not need to consider harmony and other attributes of the music. It is only necessary to consider whether the rhythms of the two pieces of music are too different. The rhythm ratio can be used for measuring the rhythm difference of two pieces of music. The rhythm ratio refers to the ratio of beats per minute (bpm) of the two pieces of music. When the rhythm ratio is too large, changing the rhythm of one phrase is abrupt, and therefore, replacement is not suitable. When the rhythm ratio is between 0.7 and 1.3, if the energy of the two phrases is greater than a preset value, replacement can be carried out. Preset values here. The time point is start time of the phrase. The duration is the time of the phrase. The rhythm ratio is recorded, facilitating subsequent mixing.

Mixing point calculation of melody and bass: harmony-based comparison is used here. The harmony-based comparison includes two parts: one is chord comparison and one is chroma vector feature comparison. The chord comparison is chord sequence comparison between chord of each beat of the phrase and chord of each beat of the other phase. Here, if only a chord root is considered, there are 12 types of chords. Each chord is represented by a letter, namely, C, C #, D, D #, E, F, F #, G, G #, A, A #, B. If chord of a certain beat is empty, N is used for representing it. The chord comparison is equivalent to the comparison of chord character strings of phrases. A local comparison method in bioinformatics is applied here to compare two chord character strings. Local comparison is to measure the similarity between two sequences by using character difference therebetween. If the difference between the characters at corresponding positions in the two sequences is large, the similarity between the sequences is low, and on the contrary, the similarity between the sequences is high. Therefore, the difference between two chords is the difference between corresponding character strings, and the similarity between two phrases can be calculated by using scores based on harmonious degrees of the music. When the sequence comparison is carried out, there are two issues directly affecting similarity scores: a substitution matrix and gap penalty. The substitution matrix adopts substitution scores of chords shown in the table below:

| Chord difference (the number of semitone differences) | score |
|---|---|
| 0 | 2.85 |
| 1 | -2.85 |
| 2 | -2.475 |
| 3 | -0.825 |
| 4 | -0.825 |
| 5 | 0 |
| 6 | -1.8 |

The gap penalty is 0. If N is compared with any chord, the score is 0. The sum of comparison scores of each phrase is the chord score of this phrase. If CGFF is compared with AGEF, the score is -0.825+2.85-2.85+2.85=2.025.

The chroma vector feature calculates the cosine similarity between the chroma vectors of two phrases. The two scores are added together after being assigned different weights according to needs. If the score is low, the tonality of the compared phrase is transposed to the tonality of the verse phrases for once more comparison. If the result score is high enough, the start time of the phrase is the time of the mixing point. The phrases’ lengths, the phrases’ rhythm ratios, and the number of transposed semitones also need to be recorded, facilitating mixing. In this embodiment, the weights of the two scores are both 0.5.

Mixing point calculation of the vocal track: the mixing points of the vocal track are similar to the mixing points of the melody and bass. If the energy of the phrase (melody + bass) in which the vocal track appears is strong enough, the mixing points of the phrase corresponding to the melody and bass are directly used. If the energy of the melody and bass is insufficient, the cosine similarity between chroma vectors of two vocal track phrases is directly compared. The start time of the phrases, the lengths of the phrases, the rhythm ratios of the phrases, and the number of transposed semitones is also recorded.

When the automatic mixing device is applied, all pieces of music in a user music library are preprocessed. Using the music feature calculation method and the mixing point calculation method described above, any piece of music in the music library is used as the verse, and the mixing points of this piece of music and the other pieces of music are respectively calculated and stored in a database. Suppose enough mixing points are found with the different pieces of music when this piece of music is used as the verse, and the two conditions that the rhythm ratio of the other pieces of music to the verse is 0.7-1.3 and the tonality difference is within 3 are met. In that case, the different pieces of music meeting the conditions are used as similar music of this piece of music, and these pieces of music are directly used during mixing.

In conclusion, the automatic mixing device of the present invention respectively calculates the music features of a plurality of tracks and calculates the mixing points based on the calculated features, such that automatic mixing is realized, and the problems of low mixing efficiency, unnatural mixing result and high error rate in the prior art are solved.

The above embodiments are merely illustrative of the principles of the present invention and the effects thereof, and are not intended to limit the present invention. Any person skilled in the art may make modifications or changes to the embodiments described above without departing from the spirit and scope of the present invention. Therefore, all equivalent modifications or changes made by a person of ordinary skill in the art without departing from the spirit and technical idea disclosed herein should still be covered by the claims of the present invention.

1. An automatic mixing device, comprising:
a music feature calculator, input music of the music feature calculator comprising a plurality of tracks;
the music feature calculator selecting one or more of melody, bass, percussion music, and vocal tracks, and calculating one or more features of the input music comprising beat point time, a chord at a downbeat, a chroma vector at a downbeat, sound energy at a downbeat, tonality, and tempo.

2. The automatic mixing device according to claim 1, further comprising a mixing point calculator.

3. The automatic mixing device according to claim 2, wherein the mixing point calculator respectively calculates mixing points of a vocal track part, a melody and bass track part and a percussion music track part of the music.

4. The automatic mixing device according to claim 3, wherein when the rhythm ratio of two phrases is between 0.7 and 1.3, start points of the two phrases are taken as the mixing points of the percussion music track part.

5. The automatic mixing device according to claim 3, wherein the calculating mixing points of a melody and bass track part is based on harmony comparison of the music, and the harmony comparison comprises chord comparison and chroma vector comparison.

6. The automatic mixing device according to claim 5, wherein a method for the harmony comparison comprises:
representing chord roots with characters, and converting phrases into character strings;
comparing the character strings and calculating the differences of respective characters in the character strings; and
calculating chord similarity according to the differences.

7. The automatic mixing device according to claim 6, wherein the differences of respective characters in the character strings are calculated by using a substitution matrix and gap penalty.

8. The automatic mixing device according to claim 5, wherein the chroma vector comparison comprises calculating the cosine similarity between chroma vectors of two phrases.

9. The automatic mixing device according to claim 3, wherein the calculating mixing points of a vocal track part comprises:
judging whether the vocal track part comprises melody and bass, if yes, directly using mixing points of phrases corresponding to the melody and bass, and if no, comparing the cosine similarity between chroma vectors of vocal track phrases.

10. The automatic mixing device according to claim 1, wherein the input to the music feature calculator comprises melody, vocal, and percussion music tracks.

11. The automatic mixing device according to claim 1, wherein only the melody, bass, and percussion music tracks are selected when calculating beat points of the music.

12. The automatic mixing device according to claim 1, wherein when calculating the beat point time of the music, the beat point time of the music is calculated by using a plurality of recurrent neural networks based on deep learning, or music beats are found according to a method for the correlation of music occurrence time.

13. The automatic mixing device according to claim 12, wherein the time of the first downbeat is calculated from the calculated beat time through a hidden Markov model.

14. The automatic mixing device according to claim 1, wherein the melody and bass tracks are selected when calculating the chord at a downbeat.

15. The automatic mixing device according to claim 1, wherein the formula for calculating the tempo is
$$\frac{60}{b e a {t}_{i + 1} - b e a {t}_{i}}$$
where beat refers to a beat in a phrase, and i is a sequence number of the beat.

16. The automatic mixing device according to claim 1, wherein i is within a range of 20-90.

17. The automatic mixing device according to claim 1, further comprising a music segmenter configured to divide the music prior to calculating mixing points.

18. The automatic mixing device according to claim 17, wherein the music segmenter divides the music using a music structure feature-based method.

19. The automatic mixing device according to claim 18, wherein the music segmenter divides the music into phrases that are integer multiples of 4 bars.
